(19) United States
(12) Patent Application Publication
(10) Pub. No.: US 2026/0346559 A1
(43) Pub. Date: Nov. 5, 2026

(54) A METHOD OF MANUFACTURING A PLURALITY OF WIND TURBINE BLADES

(71) Applicant: Vestas Wind Systems A/S, Aarhus N (DK)

(72) Inventor: Robin John Kennard, South Fremantle (AU)

(73) Assignee: Vestas Wind Systems A/S, Aarhus N (DK)

(21) Appl. No.: 19/486,432

(22) PCT Filed: May 23, 2024
(86) PCT No.: PCT/DK2024/050122

§ 371 Date: Nov. 21, 2025

(30) Foreign Application Priority Data
May 25, 2023 (DK) PA202370251

(51) Int. Cl. B29D 99/00; B29K 307/04; F03D 1/06

(52) U.S. Cl. CPC B29D 99/0028; F03D 1/0675; B29K 2307/04

(57) ABSTRACT

The present disclosure relates to a method of manufacturing wind turbine blades. The method comprises the steps of: providing leeward and windward shell mould surface geometries; and manufacturing a first and a second blade by the sub-steps of: moulding a leeward shell and a windward shell in the shell mould surface geometries; engaging a main and a rear leeward reinforcement structure with the leeward shell; engaging a main and a rear windward reinforcement structure with the windward shell; and forming the first blade from the leeward shell and the windward shell. The first blade and the second blade have the same external geometry. Manufacturing the first blade further comprises the sub-step of: arranging a first trailing edge reinforcement structure at the trailing edge of the first blade, the first trailing edge reinforcement structure comprising fibres aligned with the trailing edge of the first blade.

### TECHNICAL FIELD

The present invention relates to a method of manufacturing a plurality wind turbine blades, particularly wind turbine blades for horizontal-axis wind turbines. The invention further relates to a family of wind turbine blades.

### BACKGROUND OF THE INVENTION

As a part of the worldwide transition into renewable energy, there is a demand for wind turbines of increased size and efficiency. Mechanical properties of wind turbine blades, however, impose limitations on the size of the blades and thus on the power output of wind turbines. During use, wind turbine blades are subject to static and dynamic loads incurred by the wind acting on the blades, i.e., aerodynamic loads, as well as gravitational loads.

Loads induced by wind acting on a wind turbine blade are generally referred to as flapwise loads, and loads induced by gravity are generally referred to as edgewise loads. During use of the blade, its pressure side is generally subjected to tension, and its suction side is generally subjected to compression.

The pressure side can also be referred to as the windward side, and the suction side can also be referred to as the leeward side.

To counteract loads on blades, reinforcement structures such as spar caps may be embedded or attached in wind turbine blades to engage with leeward and/or windward shell portions to provide enhanced tensile and/or compressive strength. Further, such reinforcement structures may be interconnected by shear webs. Reinforcement structures such as spar caps may include longitudinally aligned carbon fibres integrated in, e.g., pultruded elements which may be designed to resist a certain predetermined level of tensile and compressive loads.

Pultruded elements provide a high stiffness and are therefore used in many modern wind turbine blades. However, the geometry of pultruded elements impose significant constraints as to how and where these elements can be positioned in the blade.

Conventionally, a given wind turbine blade of a particular size is typically designed and manufactured to meet a certain set of requirements with respect to edgewise and flapwise loads under a particular set of operation conditions. Such conditions may for example be local weather conditions, required lifetime/maintenance of the blades, power output of the wind turbine, etc.

The design of a blade may be indicative of the number of pultruded elements to use in the reinforcement structures and/or where the reinforcement structures are placed to engage the shells of the blade.

A blade design for one set of operation conditions is typically not optimal for another set of operation conditions. Yet, redesigning the entire blade is a cumbersome process and will typically require new manufacturing equipment such as new shell moulds.

Consequently, it is generally challenging to manufacture blades which have to meet different set of operation conditions.

Accordingly, there is a need for manufacturing concepts which allow cost-efficient production of blades which are capable of meeting different sets of operation conditions.

### SUMMARY OF THE INVENTION

On the above background, it is an object of preferred embodiments of the invention to provide cost-efficient production of wind turbine blades which are capable of meeting different sets of operation conditions, relying minimally on designing new manufacturing equipment for the blade.

A first aspect of the present disclosure relates to a method of manufacturing a plurality of wind turbine blades, the method comprising the steps of:
providing a leeward shell mould surface geometry and a windward shell mould surface geometry; and
manufacturing a first blade of the plurality of wind turbine blades by the sub-steps of:
   moulding a leeward shell for the first blade using the leeward shell mould surface geometry and a windward shell for the first blade using the windward shell mould surface geometry;
   engaging a main leeward reinforcement structure for the first blade and a rear leeward reinforcement structure for the first blade with the leeward shell for the first blade;
   engaging a main windward reinforcement structure for the first blade and a rear windward reinforcement structure for the first blade with the windward shell for the first blade; and
   forming the first blade from the leeward shell and the windward shell such that the first blade extends in a spanwise direction between a root end and a tip end of the first blade, in a thickness direction between the leeward shell and the windward shell, and in a chordwise direction between a leading edge and a trailing edge of the first blade,
wherein the main windward reinforcement structure, the main leeward reinforcement structure, the rear windward reinforcement structure, and the rear leeward reinforcement structure of the first blade each extend in the spanwise direction of the first blade, wherein the main windward reinforcement structure and the main leeward reinforcement structure of the first blade forms a first main reinforcement structure and the rear windward reinforcement structure and the rear leeward reinforcement structure of the first blade forms a first rear reinforcement structure arranged between the first main reinforcement structure and the trailing edge of the first blade;
wherein the method further comprises the step of manufacturing a second blade of said plurality of wind turbine blades by the sub-steps of:
   moulding a leeward shell for the second blade using the leeward shell mould surface geometry and a windward shell for the second blade using the windward shell mould surface geometry;
   engaging a main leeward reinforcement structure for the second blade and a rear leeward reinforcement structure for the second blade with the leeward shell for the second blade;
   engaging a main windward reinforcement structure for the second blade and a rear windward reinforcement structure for the second blade with the windward shell for the second blade; and
   forming the second blade from the leeward shell and the windward shell such that the second blade extends in a spanwise direction between a root end and a tip end of the second blade, in a thickness direction between the leeward shell and the windward shell, and in a chordwise direction between a leading edge and a trailing edge of the second blade,
wherein the main windward reinforcement structure, the main leeward reinforcement structure, the rear windward reinforcement structure, and the rear leeward reinforcement structure of the second blade each extend in the spanwise direction of the second blade, wherein the main windward reinforcement structure and the main leeward reinforcement structure of the second blade forms a second main reinforcement structure and the rear windward reinforcement structure and the rear leeward reinforcement structure of the second blade forms a second rear reinforcement structure arranged between the second main reinforcement structure and the trailing edge of the second blade;
wherein the first blade and the second blade have the same external geometry,
wherein the main windward reinforcement structure and the main leeward reinforcement structure of the first main reinforcement structure and the second main reinforcement structure comprise layers of pultruded carbon fibres,
wherein a number of layers of pultruded glass fibres in the rear windward reinforcement structure and the rear leeward reinforcement structure of the first rear reinforcement structure is different from a number of layers of pultruded glass fibres in the rear windward reinforcement structure and the rear leeward reinforcement structure of the second rear reinforcement structure,
wherein manufacturing the first blade comprises the sub-step of:
   arranging a first trailing edge reinforcement structure between the first rear reinforcement structure and the trailing edge of the first blade, the first trailing edge reinforcement structure comprising fibres engaging the leeward shell and/or the windward shell and aligned with the trailing edge of the first blade.

The first aspect of the present disclosure is directed at manufacturing different wind turbine blades which are capable of meeting different sets of operation conditions while relying minimally on designing new manufacturing equipment. In particular, the shell mould surface geometry can be re-used.

Re-usage of the same shell mould surface geometries can be facilitated by using the same leeward and windward shell moulds to manufacture the plurality of blades. Alternatively, re-usage of the same shell mould surface geometries can also be facilitated by using different leeward and windward shell moulds having the same surface geometries to manufacture a plurality of blades in different shell moulds, providing blades with the same external geometry. Thereby, the plurality of blades may, for example, be manufactured at different blade manufacturing facilities, albeit relying on the same leeward and windward shell mould surface geometries.

The conditions for cost-efficiently manufacturing different wind turbine are provided by relying on main reinforcement structures comprising layers of pultruded carbon fibres, and rear reinforcement structures comprising layers of pultruded glass fibres. This is combined with one or more trailing edge reinforcements structures comprising fibres aligned with the trailing edge of the blade.

Typical modern wind turbine blades rely on a main reinforcement structure and a rear reinforcement structure based on layers of pultruded carbon fibres to provide the required strength of the blade.

Traditionally, the main reinforcement structure is primarily directed at carrying flapwise loads acting on the blade and the rear reinforcement structure is primarily directed at carrying edgewise loads acting on the blade. However, the placement of the rear reinforcement structure is significantly constrained due to the airfoil shape of the blade. As a result, the ability of the rear reinforcement structure to resist edgewise bending may be suboptimal.

According to the present disclosure, in comparison with conventional blades, at least one of the first and the second blades is manufactured with layers of pultruded glass fibres in the rear reinforcement structure. A number of layers of pultruded glass fibres in the rear windward and the rear leeward reinforcement structure of the first rear reinforcement structure is different from a number of layers pultruded glass fibres in the rear windward reinforcement structure and the rear leeward reinforcement structure of the second rear reinforcement structure. For example, the first rear reinforcement structure comprises layers of pultruded glass fibres, whereas the second rear reinforcement structure does not comprise layers of pultruded glass fibres. In that case, layers of pultruded carbon fibres in the first blade may be considered as to have been replaced by layers of pultruded glass fibres.

At least the first blade is provided with a trailing edge reinforcement structure between the first rear reinforcement structure and the trailing edge of that blade. Such a trailing edge reinforcement structure does not rely on pultruded elements, but may instead rely on, e.g., fibres unidirectionally arranged in a fabric of material. In isolation, such a trailing edge reinforcement structure typically has a lower stiffness than a pultruded element. However, its positioning does not suffer from the same constraints as pultruded elements, which are restricted in relation to placement in the blade due to size and rigidity of these elements and due to the airfoil shape of the blade. Thereby, the trailing edge reinforcement structure can be located between the rear reinforcement structure and the trailing edge, preferably at and aligned with the trailing edge, which results in an efficient way of stiffening the blade to resist edgewise bending loads. As the trailing edge reinforcement structure can be positioned close to or at the trailing edge of the blade it is far from the neutral axis of the blade (compared to the rear reinforcement structures).

In addition, the placement of the trailing edge reinforcement structure also efficiently implements resistance to torsional loads which in turn provide aerodynamic stability.

This means that the trailing edge reinforcement structure is better placed for contributing to the edgewise stiffness and/or torsional stiffness of the blade than the rear reinforcement structures. This allows the trailing edge reinforcement structure to efficiently compensate for the lower stiffness of the rear reinforcement structure due to, e.g., replacement of layers of pultruded carbon fibres with layers of pultruded glass fibres in the rear reinforcement structure.

Thereby, within the scope of the present disclosure, both the number of layers of pultruded carbon fibres, the number of layers of pultruded glass fibres, and any trailing edge reinforcement structure may be varied, which significantly improves flexibility of redesigning and manufacturing wind turbine blades. The properties of a blade with a given external shell geometry can be varied by changing the number of pultruded layers of carbon/glass fibres and by adding/changing a trailing edge reinforcement structure, or by some combination thereof. In contrast, new shell mould surface geometries are required according to conventional production methods.

Typically, the leeward shell is the portion of the shell of the wind turbine blade located at a leeward side of the wind turbine blade. Similarly, the windward shell is typically the portion of the shell of the wind turbine blade located at the windward side of the wind turbine blade. The leeward shell and the windward shell may be interconnected at the trailing edge and/or at the leading edge.

The leeward shell and the windward shell typically define an airfoil profile of the wind turbine blade configured to generate a lift corresponding to an aerodynamic pressure difference between the windward shell portion and the leeward shell portion.

Part of the wind turbine blade may have a truncated trailing edge to define a flatback airfoil section. A flatback airfoil section can provide improved aerodynamic properties, and the reduced chord makes the blade easier to produce and transport. The flatback section can also provide an area which is particularly well-suited to accommodate a trailing edge reinforcement structure and the trailing edge reinforcement structure can provide the required edgewise load-carrying capability in this flatback section. Preferably therefore, the trailing edge reinforcement structure is arranged adjacent to the truncated trailing edge.

A windward/leeward reinforcement structure according to the present disclosure typically extends in the spanwise direction. It engages with a shell to thereby resist deformation of that shell, thereby counteracting flapwise and edgewise bending and/or torsional loads. A reinforcement structure may be integrated into a shell portion or bonded to a shell portion to engage that shell portion. An example of a reinforcement structure is a spar cap known per se.

Wind turbine blades according to examples of the present disclosure comprise both a main reinforcement structure and a rear reinforcement structure, each of these arrangements comprising at least two reinforcement structures, one engaging each respective shell. The leeward/windward reinforcement structures of the main reinforcement structure typically resist deformation of a leading part of the blade, and may in particular resist flapwise bending. The leeward/windward reinforcement structures of the rear reinforcement structure resist deformation of a trailing part of the blade, and may in particular resist edgewise bending.

The first rear reinforcement structure may be arranged so that it is non-parallel to the first main reinforcing structure and second rear reinforcement structure may be arranged so that it is non-parallel to the second main reinforcing structure. The leeward/windward reinforcement structures of the main reinforcement structures may be arranged non-parallel to the leeward/windward reinforcement structures of the rear reinforcement structures. The non-parallel arrangement is seen in a planform view of the blade, looking in the thickness direction down on the blade.

Arranging the rear reinforcement structure of each blade so that it is non-parallel to the main reinforcing structure of that blade allows the rear reinforcement structure to be more closely positioned to the trailing edge over its length so that it can resist deformation of the trailing edge of the blade.

The leeward/windward reinforcement structures of a reinforcement structure may be interconnected by a shear web. For example, the main leeward reinforcement structure and the main windward reinforcement structure may be interconnected by at least one main web, and/or the rear leeward reinforcement structure and the rear windward reinforcement structure may be interconnected by at least one rear web.

Typically, the main reinforcement structure comprises two reinforcement structures, but in some examples, the main reinforcement structure comprises more than two windward/leeward reinforcement structures, for example three windward/leeward reinforcement structures or four windward/leeward reinforcement structures.

Similarly, the rear reinforcement structure typically comprises two windward/leeward reinforcement structures, but it may comprise more reinforcement structures, such as three or four windward/leeward reinforcement structures.

In case a reinforcement structure comprises more than two windward/leeward reinforcement structures, these are typically interconnected by more than one shear web.

Two blades having the same external geometry may be quantified by length in spanwise direction, length in chordwise direction, length in thickness direction, cross-sectional airfoil shape along various spanwise positions of the blade, or some combination thereof. Using the same leeward and windward shell mould surface geometries for two blades will provide the same external geometry.

In examples of the present disclosure, the fibres of the first trailing edge reinforcement structure are primarily unidirectionally arranged in a first fabric of material.

In examples of the present disclosure, the first fabric of material is in the form of tape.

According to the present disclosure, when fibres of the trailing edge reinforcement structure are primarily unidirectionally arranged in a fabric, at least 70% of the fibres are aligned, for example at least 80% of the fibres are aligned, such as at least 90% of the fibres are aligned.

Preferably, the fibres of the trailing edge reinforcement structure are aligned with the trailing edge of the blade locally, so that as the trailing edge changes direction, so do the direction of the fibres. The trailing edge changes direction due to its curvature along the spanwise direction.

An example of fibres of the trailing edge reinforcement material in the trailing edge reinforcement structure being primarily unidirectionally arranged in a fabric of material in the form of tape is unidirectional tape (UD tape).

The provision of a fabric of material, in particular in the form of a tape, may ensure that the trailing edge reinforcement structure can be easily applied to engage the leeward shell and/or the windward shell during any step of manufacturing the blade. Further, such implementation of fibres can ensure that the fibres can be adapted to the shape of the trailing edge, which typically has a non-linear curvature along the spanwise direction which does not allow straightforward implementation of, e.g., pultruded layers of fibres. Preferably therefore, the trailing edge reinforcement structure does not comprise pultruded elements.

In examples of the present disclosure, manufacturing the second blade comprises the sub-step of:
arranging a second trailing edge reinforcement structure between the second rear reinforcement structure and the trailing edge of the second blade, the second trailing edge reinforcement structure comprising fibres engaging the leeward shell and/or the windward shell and aligned with the trailing edge of the first second,
wherein the first trailing edge reinforcement structure and the second trailing edge reinforcement structure are different,
wherein, optionally, the fibres of the second trailing edge reinforcement structure are primarily unidirectionally arranged in a second fabric of material, for example wherein the second fabric of material is in the form of tape.

The flexibility in manufacturing blades is greater when utilizing different trailing edge reinforcement structures.

The structure may for example be different due to different stiffness in the spanwise direction, different type of structure, different materials (e.g. different amounts of carbon/glass fibres), different amount of material used, different placement onto the blade, etc.

A first rear reinforcement structure having a greater stiffness than the second rear reinforcement structure may for example be combined with a second trailing edge reinforcement structure having a greater stiffness than the first trailing edge reinforcement structure.

In examples of the present disclosure, the fibres of the first trailing edge reinforcement structure are carbon fibres and/or glass fibres.

In examples of the present disclosure, the fibres of the second trailing edge reinforcement structure are carbon fibres and/or glass fibres.

In general, carbon fibres have an improved stiffness, and glass fibres have a reduced cost.

In examples of the present disclosure, the first trailing edge reinforcement structure is aligned with the trailing edge of the first blade along a mid-span section of the first blade in which the trailing edge has a non-linear curvature along the spanwise direction. Optionally, the second trailing edge reinforcement structure is aligned with the trailing edge of the second blade along a mid-span section of the second blade in which the trailing edge has a non-linear curvature along the spanwise direction.

The non-linear curvature of the trailing edge is in a chordwise direction of the blade. In other words, when looking down on the blade in the thickness direction (the thickness direction being substantially perpendicular to the chordwise direction and substantially perpendicular to the spanwise direction) the non-linear curvature will be seen along the trailing edge.

Placement of a trailing edge reinforcement structure in such a section of the blade may advantageously ensure optimal resistance of edgewise bending and/or torsion.

In examples of the present disclosure, the number of layers of pultruded glass fibres in the rear windward reinforcement structure and/or the rear leeward reinforcement structure of the first rear reinforcement structure is greater than the number of layers of pultruded glass fibres in the respective rear windward reinforcement structure and/or the rear leeward reinforcement structure of the second rear reinforcement structure.

For example, the first blade comprises a first main reinforcement structure primarily based on layers of pultruded carbon fibres, a first rear reinforcement structure primarily based on layers of pultruded glass fibres, and a trailing edge reinforcement structure, whereas the second blade comprises a second main reinforcement structure primarily based on layers of pultruded carbon fibres, and second rear reinforcement structure primarily based on layers of pultruded carbon fibres.

Such a combination of blades is straightforward to manufacture and can find applications under different sets of operation conditions.

In examples of the present disclosure, the rear windward reinforcement structure and the rear leeward reinforcement structure of the first rear reinforcement structure comprises layers of pultruded carbon fibres and/or the rear windward reinforcement structure and the rear leeward reinforcement structure of the second rear reinforcement structure comprises layers of pultruded carbon fibres.

In examples of the present disclosure, a number of layers of pultruded carbon fibres in the rear windward reinforcement structure and/or the rear leeward reinforcement structure of the first rear reinforcement structure is different from a number of layers of pultruded carbon fibres in the respective rear windward reinforcement structure and/or the rear leeward reinforcement structure of the second rear reinforcement structure.

A rear windward/leeward reinforcement structure can optionally comprise both layers of pultruded carbon fibres and layers of pultruded glass fibres. This further enhances flexibility of manufacturing wind turbine blades for different sets of operation conditions.

If only one of the first and the second blades comprises layers of pultruded carbon fibres in the rear reinforcement structure, the first and the second rear reinforcement structures may be considered as to comprise different numbers of layers of pultruded carbon fibres.

In examples of the present disclosure, the number of layers of pultruded carbon fibres in the rear windward reinforcement structure and/or the rear leeward reinforcement structure of the first rear reinforcement structure is smaller than the number of layers of pultruded carbon fibres in the respective rear windward reinforcement structure and/or the rear leeward reinforcement structure of the second rear reinforcement structure.

Generally, having a reduced number of layers of pultruded carbon fibres in a respective rear windward/leeward reinforcement structure of the first rear reinforcement structure (in comparison with the second rear reinforcement structure and in combination with a first trailing edge reinforcement structure) can provide a cost-efficient blade.

In examples of the present disclosure, a total number of layers of pultruded fibres and a thickness resulting thereof in the rear windward reinforcement structure is the same in the first rear reinforcement structure and the second windward reinforcement structure, and/or wherein a total number of layers of pultruded fibres and a thickness resulting thereof in the rear leeward reinforcement structure is the same in the first rear reinforcement structure and the second windward reinforcement structure.

The provision of a total number of layers of pultruded fibres (i.e., number of layers of pultruded carbon fibres and of pultruded glass fibres) such that the thickness resulting thereof is the same in corresponding reinforcement structures of the two blades simplifies manufacturing of the blades significantly. In particular, this will typically result in the shell thickness of the first and second blades being the same, such that the same webs can be used, and/or any core material adjacent to the layers of pultruded fibres can be the same for the first and second blades.

In examples of the present disclosure, within a first airfoil section of the first blade, the rear windward reinforcement structure and the rear leeward reinforcement structure of the first rear reinforcement structure has a first stiffness in the spanwise direction,
wherein, within a second airfoil section of the second blade, the rear windward reinforcement structure and the rear leeward reinforcement structure of the second rear reinforcement structure has a second stiffness in the spanwise direction, wherein a position of the first airfoil section in the first blade corresponds to a position of the second airfoil section in the second blade, wherein the first stiffness is less than the second stiffness.

Generally, the first blade having a first stiffness less than a second stiffness in combination with a first trailing edge reinforcement structure can provide a cost-efficient blade.

The stiffness of an element is a measure which is indicative of the extent to which an object resists deformation in response to an applied force. Typically, the stiffness k is quantified as k=F/d, where F is a force and d is a displacement.

The stiffness is different from the elastic modulus of a material, but the stiffness of a given reinforcement structure does depend on the elastic modulus of the material or materials, from which that reinforcement structure is made. For example, for an exemplary element the stiffness is k=E×A/L, where E is the elastic modulus, A is cross-sectional area (transverse to direction of tension/compression) and L is the length of the element.

Examples of the present disclosure provide that a second stiffness (of the rear windward reinforcement structure and the rear leeward reinforcement structure of the second rear reinforcement structure) is greater than a first stiffness (of the rear windward reinforcement structure and the rear leeward reinforcement structure of the first rear reinforcement structure) at given airfoil sections of the wind turbine blades. The airfoil section is transverse to the spanwise direction.

These first and second stiffnesses are the total stiffness of both the rear windward reinforcement structure and the rear leeward reinforcement structure. Typically, such stiffnesses are determined mainly by the layers of pultruded fibres utilized in a given reinforcement structure.

In examples of the present disclosure, within the first airfoil section, the first trailing edge reinforcement structure has a first supplementary stiffness in the spanwise direction, wherein, within the second airfoil section, the second trailing edge reinforcement structure has a second supplementary stiffness in the spanwise direction, wherein the first supplementary stiffness is greater than the second supplementary stiffness.

Complementing a second stiffness greater than a first stiffness with a first supplementary stiffness greater than a second supplementary stiffness may ensure cost-efficient manufacturing of blades.

For some types of reinforcement structures, the stiffness in tension and the stiffness in compression may be different. In such cases, the relevant stiffnesses may be the stiffnesses in tension. That is, in some examples of the present disclosure, the first stiffness, the second stiffness and the supplementary stiffnesses are tensional stiffnesses.

In examples of the present disclosure, the main windward reinforcement structure and the main leeward reinforcement structure of the first main reinforcement structure have the same number of layers of pultruded fibres as the respective main windward reinforcement structure and the main leeward reinforcement structure of the second main reinforcement structure, and/or wherein the main windward reinforcement structure and the main leeward reinforcement structure of the first main reinforcement structure have the same material composition of layers of pultruded fibres as the respective main windward reinforcement structure and the main leeward reinforcement structure of the second main reinforcement structure.

In examples of the present disclosure, the main windward reinforcement structure and the main leeward reinforcement structure of the first main reinforcement structure comprises the same number of layers of pultruded carbon fibres as the main windward reinforcement structure and the main leeward reinforcement structure of the second main reinforcement structure.

Typically, the rear reinforcement structure and the trailing edge reinforcement structure primarily affect the edgewise stiffness of the blade, whereas the main reinforcement structure primarily affects the flapwise stiffness of the blade.

Thereby, by not changing the main reinforcement structures between the blades, the edgewise stiffness can be selectively adapted while minimally changing the flapwise stiffness. In examples of the present disclosure, a placement of the first main reinforcement structure in the first blade is the same as a placement of the second main reinforcement structure in the second blade; and/or wherein a placement of the first rear reinforcement structure in the first blade is the same as a placement of the second rear reinforcement structure in the second blade.

In this context, placement of a reinforcement structure may also be referred to as location of a reinforcement structure.

By maintaining the same placement of reinforcement structures between the blades, manufacturing of different blades is simplified.

In examples of the present disclosure, for each of the first blade and the second blade, the main reinforcement structure comprises a main web interconnecting the main windward reinforcement structure and the main leeward reinforcement structure, and/or the rear reinforcement structure comprises a rear web interconnecting the rear windward reinforcement structure and the rear leeward reinforcement structure.

As a result, the leeward and windward reinforcement structures can be rigidly interconnected.

In examples of the present disclosure, a length of the rear windward reinforcement structure of the first rear reinforcement structure in the spanwise direction is the same as a length of the rear windward reinforcement structure of the second rear reinforcement structure in the spanwise direction, and/or wherein a length of the rear leeward reinforcement structure of the first rear reinforcement structure in the spanwise direction is the same as a length of the rear leeward reinforcement structure of the second rear reinforcement structure in the spanwise direction.

By maintaining the same length of reinforcement structures between the blades, manufacturing of different blades is simplified.

In examples of the present disclosure, the leeward shell mould surface geometry is provided by a leeward shell mould and the windward shell mould surface geometry is provided by a windward shell mould, wherein the leeward shell mould and the windward shell mould are each used in both of said sub-steps of:
moulding the leeward shell for the first blade using the leeward shell mould surface geometry and the windward shell for the first blade using the windward shell mould surface geometry; and
moulding the leeward shell for the second blade using the leeward shell mould surface geometry and the windward shell for the second blade using the windward shell mould surface geometry.

Thereby, the plurality of wind turbine blades may, for example, be manufactured at the same blade manufacturing facility. Further separate moulds do not have to be provided for separate blades.

In examples of the present disclosure said same external geometry of the first blade and the second blade is defined by the leeward shell mould surface geometry and the windward shell mould surface geometry.

A second aspect of the present disclosure relates to a family of wind turbine blades, wherein each blade of the family comprises:
a root end and a tip end, the blade extending in a spanwise direction between the root end and the tip end;
a leading edge and a trailing edge, the blade extending in a chordwise direction between the leading edge and the trailing edge;
a leeward shell and a windward shell, the blade extending in a thickness direction between the leeward shell and the windward shell;
a main reinforcement structure, the main reinforcement structure comprising a main windward reinforcement structure engaging the windward shell and extending in the spanwise direction of the blade and a main leeward reinforcement structure engaging the leeward shell and extending in the spanwise direction of the blade; and
a rear reinforcement structure, the rear reinforcement structure comprising a rear windward reinforcement structure engaging the windward shell and extending in the spanwise direction of the blade and a rear leeward reinforcement structure engaging the leeward shell and extending in the spanwise direction of the blade, the rear reinforcement structure being arranged between the main reinforcement structure and the trailing edge,
wherein the family comprises at least a first blade and a second blade, the first blade and the second blade having the same external geometry,
the main reinforcement structure of the first blade being a first main reinforcement structure, the rear reinforcement structure of the first blade being a first rear reinforcement structure, the main reinforcement structure of the second blade being a second main reinforcement structure, and the rear reinforcement structure of the second blade being a second rear reinforcement structure,
wherein the main windward reinforcement structure and the main leeward reinforcement structure of the first main reinforcement structure and the second main reinforcement structure comprise layers of pultruded carbon fibres,
wherein a number of layers of pultruded glass fibres in the rear windward reinforcement structure and the rear leeward reinforcement structure of the first rear reinforcement structure is different from a number of layers of pultruded glass fibres in the rear windward reinforcement structure and the rear leeward reinforcement structure of the second rear reinforcement structure,
wherein the first blade further comprises a first trailing edge reinforcement structure extending in the spanwise direction of the first blade and being arranged between the first rear reinforcement structure and the trailing edge of the first blade,
wherein the first trailing edge reinforcement structure comprises fibres engaging the leeward shell and/or the windward shell and aligned with the trailing edge of the first blade.

In examples of the present disclosure, the family of blades are manufactured according to a method under the first aspect of the present disclosure.

The second aspect directed at a family of wind turbine blades may potentially provide the same or similar technical effects or advantages as the method of manufacturing wind turbine blades under the first aspect of the present disclosure.

Thereby, the family of blades under the second aspect may comprise any of the features described in relation to manufacturing wind turbine blades under the first aspect.

For example, the second blade may comprise a second trailing edge reinforcement structure extending in the spanwise direction of the second blade and being arranged between the second rear reinforcement structure and the trailing edge of the second blade.

### BRIEF DESCRIPTION OF THE DRAWINGS

Embodiments of the invention will now be further described by reference to the accompanying drawings, in which:

FIG. 1 illustrates main structural components of an exemplary horizontal-axis wind turbine comprising three wind turbine blades,

FIGS. 2a-c illustrate moulding of a windward shell and a leeward shell of a wind turbine blade,

FIGS. 3a-b illustrate cross-sectional views of a chordwise plane of a first blade and a second blade according to the present disclosure,

FIGS. 4a-b illustrate windward shells of a first blade and a second blade according to the present disclosure, and

FIG. 5 illustrates a flow chart of a method of manufacturing a plurality of wind turbine blades according to an example of the present disclosure.

### DETAILED DESCRIPTION OF THE DRAWINGS

It should be understood that the detailed description and specific examples, while indicating embodiments of the disclosure, are given by way of illustration only, since various changes and modifications within the scope of the disclosure will become apparent to those skilled in the art from this detailed description.

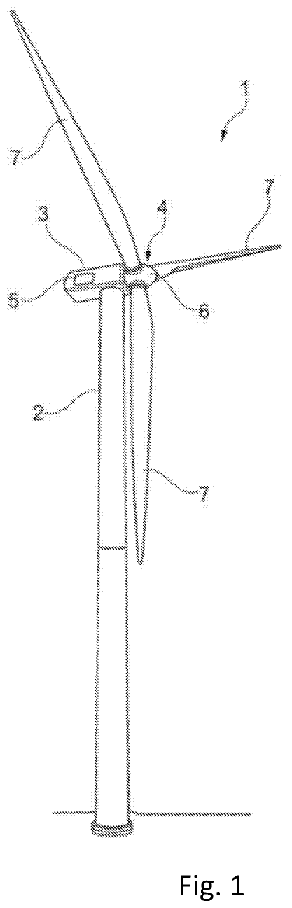

FIG. 1 illustrates main structural components of an exemplary horizontal-axis wind turbine 1 comprising three wind turbine blades 7 constituting the rotor 4 of the wind turbine. The wind turbine 1 comprises a tower 2 and a nacelle 3 mounted at top of the tower 2. The rotor is operatively coupled to a generator 5 within the nacelle 3 via a drive train (not shown) for converting mechanical kinetic energy harvested from the wind into electrical energy. In addition to the generator 5, the nacelle 3 may house additional components required to operate and optimize the performance of the wind turbine 1. The tower 2 supports the load presented by the nacelle 3, the rotor 4, and other wind turbine components within the nacelle 3.

The rotor 4 includes a central hub 6 and three elongated wind turbine blades 7 extending radially outward from the central hub 6, i.e., longitudinally in a lengthwise direction, from a root section of the blades 7 at the hub 6 to a tip section of the blades. In operation, the blades 7 are configured to interact with the passing air flow to produce lift that causes the central hub 6 to rotate about the longitudinal axis of the rotor 4. Wind speed in excess of a minimum level will activate the rotor 4 and allow it to rotate within a plane substantially perpendicular to the direction of the wind. The rotation is converted to electric power by the generator 5 and is usually supplied to the utility grid.

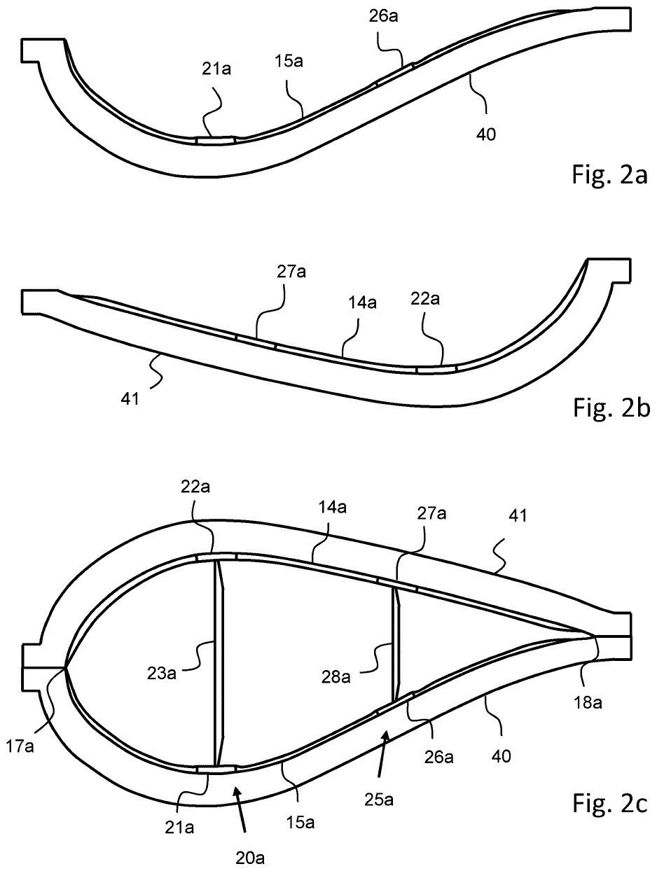

FIGS. 2a-c illustrate moulding of a windward shell 15a and a leeward shell 14a of a wind turbine blade.

Generally, different blade shell moulding processes for manufacturing single blades are well-known.

In one such typical process, a fibre glass layup is arranged onto the inner surface of a shell mould, such as the illustrated windward and leeward shell moulds 40, 41. The windward shell mould 40 has a windward shell mould surface geometry, and the leeward shell mould 41 has a leeward shell mould surface geometry. These surface geometries of the windward and leeward shell moulds 40, 41 determine the external geometry of the blades manufactured in the moulds 40, 41.

As a next step of the process, reinforcement structures, such as spar caps, are positioned onto the fibre glass layup.

Additional core material, such as foam or balsa, is typically added onto the glass fibre layup providing a low-density filling material.

Another fibre glass layup is then arranged onto the positioned reinforcement structures and core material.

Next, the moulds 40, 41 are prepared for the provision of resin, e.g., by covering the layups on the mould surface with a vacuum bag. The preparation may further include adding supplementary mould parts and/or flanges, for example at the leading edge and/or trailing edge.

Once the moulds are prepared, resin is provided to impregnate the layup, and the vacuum bag is removed after curing. This is a vacuum assisted resin transfer moulding (VARTM) system, but the blade shell may also be manufactured with pre-preg technology.

FIG. 2a illustrates a windward shell 15a in a windward shell mould 40 after providing resin and removal of the vacuum bag. In the illustrated example, two reinforcement structures, namely a main windward reinforcement structure 21a and a rear windward reinforcement structure 26a have been positioned in the windward shell 15a prior to providing resin to thereby engage the shell.

In a similar manner, FIG. 2b illustrates a leeward shell 14a in a leeward shell mould 41 after providing resin and removing a vacuum bag. Two reinforcement structures in the form of a main leeward reinforcement structure 22a and a rear leeward reinforcement structure 27a have been positioned in the leeward shell 14a.

Next, the moulded leeward shell 15a and the moulded windward shell 14a are joined at the leading edge or trailing edge. As illustrated in FIG. 2c, this step is typically performed by positioning the windward shell mould 40 and the leeward shell mould 41 on top of each other. This can then be combined with, e.g., applying adhesive at the leading edge 17a and the trailing edge 18a to join the two shells 14a, 15a.

However, note that according to some other blade shell moulding processes, the windward shell and the leeward shell are formed as a single part, albeit still relying on a leeward shell mould and a windward shell mould.

In the present example, the moulds 40, 41 are then opened to demould the blade. Subsequently, additional reinforcement structures may be arranged, for example at the leading edge and the trailing edge, for example a trailing edge reinforcement structure in the form of unidirectionally arranged fibres in a woven sheet of material in the form of tape.

Finally, finishing may be applied to the surface of the blade, such as applying paint.

Generally, blade manufacturing processes may include additional steps, such as attaching one or more webs 23a, 28a to the windward reinforcement structures 21a, 26a and the leeward reinforcement structures 22a, 27a, and/or installation of root reinforcements for securely fastening the manufactured blade onto a hub of a wind turbine.

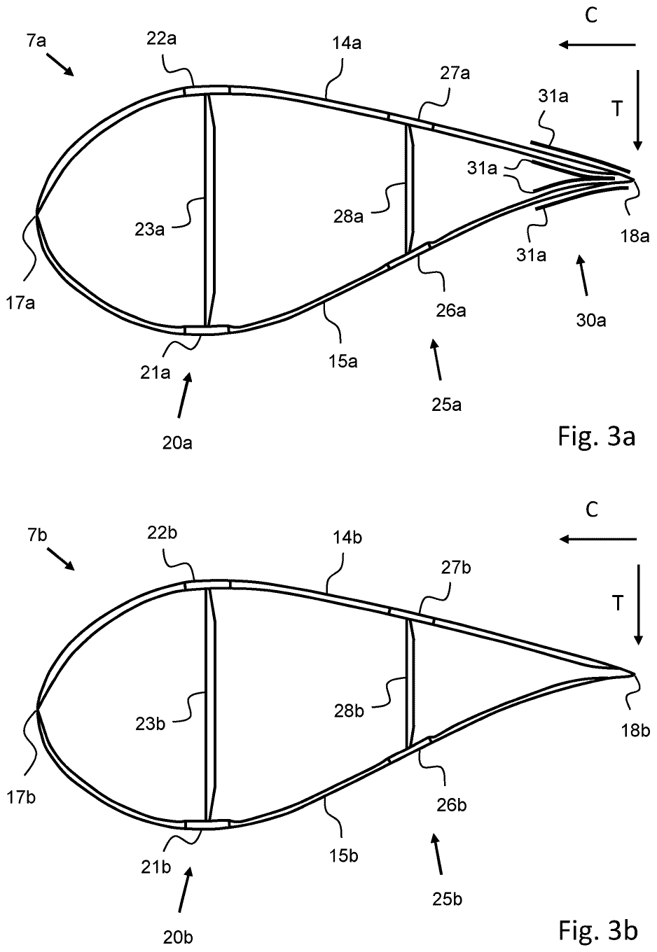

FIGS. 3a-b illustrate cross-sectional views of a chordwise plane of a first blade 7a and a second blade 7b according to the present disclosure.

Each of the two illustrated blades 7a, 7b individually extends in a chordwise direction between a leading edge 17a, 17b and a trailing edge 18a, 18b of the respective blade 7a, 7b. This chordwise direction is indicated in each subfigure by an arrow labelled with the letter “C”.

Further, each of the two illustrated blades 7a, 7b extend in a thickness direction between the leeward shell 14a, 14b and the windward shell 15a, 15b of the respective blade 7a, 7b. The thickness direction is indicated in the figure by an arrow labelled with the letter “T”. The thickness direction is substantially perpendicular to the chordwise direction.

Each of the blades 7a, 7b have been manufactured according to a blade manufacturing process such as the one presented in relation to FIGS. 2a-c. In particular, both the first blade 7a and the second blade 7b have been manufactured relying on the same windward and leeward shell mould surface geometries. The two blades have the same external geometry. Yet, the two blades are not identical.

The first blade 7a illustrated in FIG. 3a comprises a first main reinforcement structure 20a, a first rear reinforcement structure 25a, and a trailing edge reinforcement structure 30a.

The first main reinforcement structure 20a comprises a first main leeward reinforcement structure 22a and a first main windward reinforcement structure 21a interconnected by a first main web 23a. The first rear reinforcement structure 25a comprises a first rear leeward reinforcement structure 27a and a first rear windward reinforcement structure 26a interconnected by a first rear web 28a.

Each of the first main windward reinforcement structure 21a and the first main leeward reinforcement structure 22a comprises layers of pultruded carbon fibres. In comparison the first rear windward reinforcement structure 26a and the first rear windward reinforcement structure 27a comprises layers of pultruded glass fibres.

The second blade 7b illustrated in FIG. 3b comprises a second main reinforcement structure 20b and a second rear reinforcement structure 25b.

The second main reinforcement structure 20b comprises a second main leeward reinforcement structure 22b and a second main windward reinforcement structure 21b interconnected by a second main web 23b. The second rear reinforcement structure 25b comprises a second rear leeward reinforcement structure 27b and a second rear windward reinforcement structure 26b interconnected by a second rear web 28b.

Each of the second main windward reinforcement structure 21b, the second rear windward reinforcement structure 26b, the second main leeward reinforcement structure 22b, and the second rear leeward reinforcement structure 27b comprises layers of pultruded carbon fibres. This contrasts the first blade in which the first rear windward reinforcement structure 26a and the first rear windward reinforcement structure 27a comprises layers of pultruded glass fibres.

To nevertheless provide the required strength to the first blade 7a, this blade additionally comprises a trailing edge reinforcement structure 30a extending in the spanwise direction of the blade 7a and arranged between the first rear reinforcement structure 25a and the trailing edge 18a of the first blade 7a. The trailing edge reinforcement structure 30a comprises fibres aligned with the trailing edge 18a and engaging the leeward shell 14a and the windward shell 15a.

In this particular example, the fibres of the trailing edge reinforcement structure 30a are provided as glass fibres. These glass fibres are unidirectionally arranged in fabric of material 31a provided in the form of tape. Further, in this particular example, the trailing edge reinforcement structure 30a forms skins around a sandwich core of the leeward shell 14b and of the windward shell 15b. In other examples, unidirectional tape only engages a subset of these surfaces, for example the outer surfaces, the inner surfaces, the leeward shell, or the windward shell.

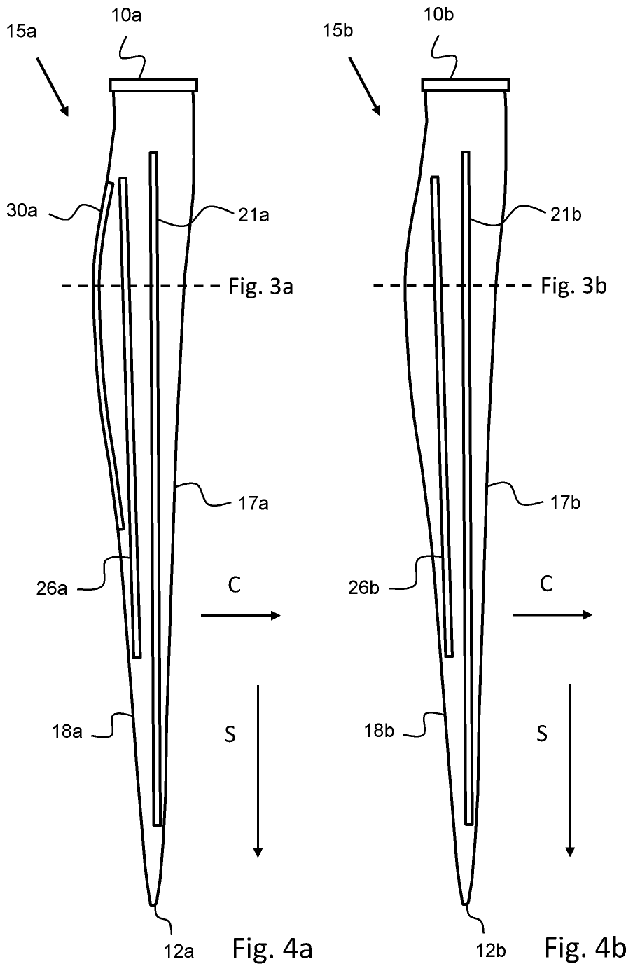

FIGS. 4a-b illustrate windward shells 15a, 15b of a first blade and a second blade according to the present disclosure. The illustrated windward shells 15a, 15b correspond to windward shells of the blades illustrated in FIGS. 3a-b. In each of the two subfigures FIG. 4a-b, a horizontal dashed line with reference to FIGS. 3a and 3b, respectively, defines the cross-sectional plane in which the blades of FIGS. 3a-b are illustrated.

Again, the chordwise direction of each of the individual windward shells 15a, 15b is indicated in each subfigure by an arrow labelled with the letter “C”.

Further, each of the two illustrated windward shells 15a, 15b extend in a spanwise direction between a root end 10a, 10b and a tip end 12a, 12b of the respective blade. This spanwise direction is indicated in each subfigure by an arrow labelled with the letter “S”. This spanwise direction is substantially perpendicular to the chordwise direction and to the thickness direction.

FIGS. 4a-b illustrate that the first windward shell 15a is engaged by a first main windward reinforcement structure 21a and a first rear windward reinforcement structure 26a, and that the second windward shell 15b is engaged by a second main windward reinforcement structure 21b and a second rear windward reinforcement structure 26b.

Each of these reinforcement structures individually extend in the spanwise direction of the blade which it engages.

As also explained in relation to FIGS. 3a-b, the first main windward reinforcement structure 21a comprises layers of pultruded carbon fibres, while the first rear windward reinforcement structure 26a comprises layers of pultruded glass fibres. In comparison, both the second main windward reinforcement structure 21b and the second rear windward reinforcement structure 26b comprises layers of pultruded carbon fibres.

In addition, FIG. 4a illustrates a trailing edge reinforcement structure 30a engaging the second windward shell 15a. The trailing edge reinforcement structure 30a is aligned with the trailing edge 18a of the blade along a mid-span section of the blade in which the trailing edge has a non-linear curvature along the spanwise direction. Thereby, the trailing edge reinforcement arrangement 30a counteract the omittance of layers of pultruded carbon fibres in the first rear reinforcement structure 26a.

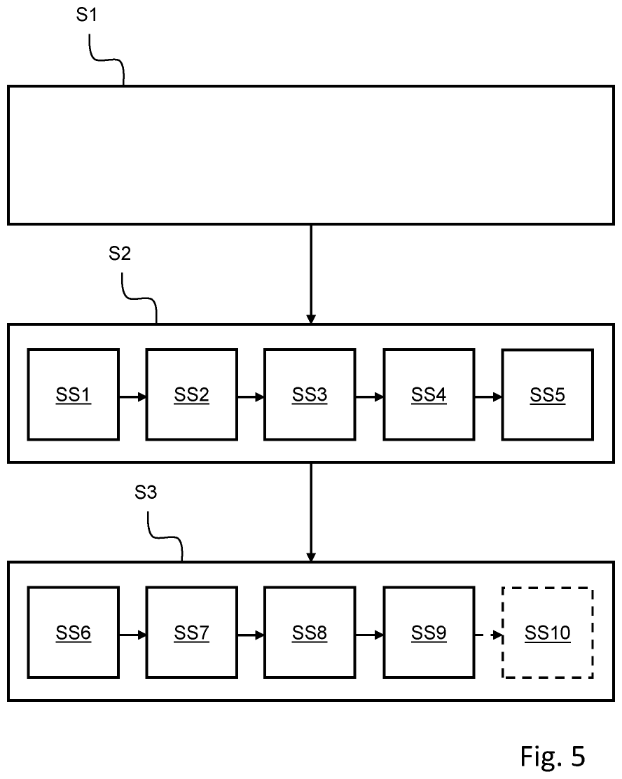

FIG. 5 illustrates a flow chart of a method of manufacturing a plurality of wind turbine blades according to an example of the present disclosure.

In a method step S1, a leeward shell mould surface geometry and a windward shell mould surface geometry are provided. These mould surface geometries may be provided by a set of leeward and windward shell moulds provided as separate parts moulding separate shells or a connected, e.g., hinged, set of moulds which can mould the windward shell and the leeward shell in a single moulding procedure. Alternatively, the mould surface geometries may be provided by separate sets of leeward and windward shell moulds, for example permitting production at different blade manufacturing facilities. Each of these sets of leeward and windward shell moulds then have the same mould surface geometries.

In another method step S2, a first blade of the plurality of wind turbine blades is manufactured.

In yet another method step S3, a second blade of the plurality of wind turbine blades is manufactured.

The scope of the present disclosure is not limited to a particular sequence of manufacturing the first and the second blade. For example, the second blade may be manufactured prior to the first blade.

The step S2 of manufacturing the first blade comprises several sub-steps SS1-SS5.

In one of these sub-steps SS1, a leeward shell (for the first blade) is moulded using the leeward shell mould surface geometry and a windward shell (for the first blade) is moulded using the windward shell mould surface geometry.

In another of these sub-steps SS2, a main leeward reinforcement structure (for the first blade) and a rear leeward reinforcement structure (for the first blade) engage with the leeward shell (for the first blade).

In another of these sub-steps SS3, a main windward reinforcement structure (for the first blade) and a rear windward reinforcement structure (for the first blade) engage with the windward shell (for the first blade).

In another of these sub-steps SS4, the first blade is formed from the leeward shell and the windward shell such that the first blade extends in a spanwise direction between a root end and a tip end of the blade, in a thickness direction between the leeward shell and the windward shell, and in a chordwise direction between a leading edge and a trailing edge of the blade. The main windward reinforcement structure, the main leeward reinforcement structure, the rear windward reinforcement structure, and the rear leeward reinforcement structure of the first blade each extend in the spanwise direction of the first blade. Moreover, the main windward reinforcement structure and the main leeward reinforcement structure of the first blade forms a first main reinforcement structure and the rear windward reinforcement structure and the rear leeward reinforcement structure of the first blade forms a first rear reinforcement structure arranged between the first main reinforcement structure and the trailing edge of the first blade.

In another of these sub-steps SS5, a first trailing edge reinforcement structure is arranged between the first rear reinforcement structure and the trailing edge of the first blade. This first trailing edge reinforcement structure comprises fibres engaging the leeward shell and/or the windward shell and aligned with the trailing edge of the first blade.

The step S3 of manufacturing the second blade similarly comprises several sub-steps SS6-SS10.

In one of these sub-steps SS6, a leeward shell (for the second blade) is moulded using the leeward shell mould surface geometry and a windward shell (for the second blade) is moulded using the windward shell mould surface geometry.

In another of these sub-steps SS7, a main leeward reinforcement structure (for the second blade) and a rear leeward reinforcement structure (for the second blade) engage with the leeward shell (for the second blade).

In another of these sub-steps SS8, a main windward reinforcement structure (for the second blade) and a rear windward reinforcement structure (for the second blade) engage with the windward shell (for the second blade).

In another of these sub-steps SS9, the second blade is formed from the leeward shell and the windward shell such that the second blade extends in a spanwise direction between a root end and a tip end of the blade, in a thickness direction between the leeward shell and the windward shell, and in a chordwise direction between a leading edge and a trailing edge of the blade. The main windward reinforcement structure, the main leeward reinforcement structure, the rear windward reinforcement structure, and the rear leeward reinforcement structure of the second blade each extend in the spanwise direction of the second blade. Moreover, the main windward reinforcement structure and the main leeward reinforcement structure of the second blade forms a second main reinforcement structure and the rear windward reinforcement structure and the rear leeward reinforcement structure of the second blade forms a second rear reinforcement structure arranged between the second main reinforcement structure and the trailing edge of the second blade.

In another of these sub-steps SS10, a second trailing edge reinforcement structure is arranged between the second rear reinforcement structure and the trailing edge of the second blade. This second trailing edge reinforcement structure comprises fibres engaging the leeward shell and/or the windward shell and aligned with the trailing edge of the second blade. This sub-step SS10 is optional, as indicated in the illustration by dashed lines.

Thereby, blades which are capable of meeting different sets of operation conditions are manufactured in a cost-efficient manner.

Generally, the engagement of a reinforcement structure with a shell may be implemented by integration into the shell (for example during moulding), or by bonding to the shell (for example, after moulding the shell). Such bonding may for example be implemented by adhesion or other well-known fastening means.

Various versions and elements of the invention have been exemplified for the purpose of clarification rather than limitation. Well-known details of methods and systems have been omitted to not obscure the content of the disclosure with redundancy. Various elements and features of the invention and this disclosure may be combined in any way possible within the scope of the claims.

1. A method of manufacturing a plurality of wind turbine blades, the method comprising the steps of:
providing a leeward shell mould surface geometry and a windward shell mould surface geometry; and
manufacturing a first blade of the plurality of wind turbine blades by the sub-steps of:
moulding a leeward shell for the first blade using the leeward shell mould surface geometry and a windward shell for the first blade using the windward shell mould surface geometry;
engaging a main leeward reinforcement structure for the first blade and a rear leeward reinforcement structure for the first blade with the leeward shell for the first blade;
engaging a main windward reinforcement structure for the first blade and a rear windward reinforcement structure for the first blade with the windward shell for the first blade; and
forming the first blade from the leeward shell and the windward shell such that the first blade extends in a spanwise direction between a root end and a tip end of the first blade, in a thickness direction between the leeward shell and the windward shell, and in a chordwise direction between a leading edge and a trailing edge of the first blade,
wherein the main windward reinforcement structure, the main leeward reinforcement structure, the rear windward reinforcement structure, and the rear leeward reinforcement structure of the first blade each extend in the spanwise direction of the first blade, wherein the main windward reinforcement structure and the main leeward reinforcement structure of the first blade forms a first main reinforcement structure and the rear windward reinforcement structure and the rear leeward reinforcement structure of the first blade forms a first rear reinforcement structure arranged between the first main reinforcement structure and the trailing edge of the first blade;
wherein the method further comprises the step of manufacturing a second blade of said plurality of wind turbine blades by the sub-steps of:
moulding a leeward shell for the second blade using the leeward shell mould surface geometry and a windward shell for the second blade using the windward shell mould surface geometry;
engaging a main leeward reinforcement structure for the second blade and a rear leeward reinforcement structure for the second blade with the leeward shell for the second blade;
engaging a main windward reinforcement structure for the second blade and a rear windward reinforcement structure for the second blade with the windward shell for the second blade; and
forming the second blade from the leeward shell and the windward shell such that the second blade extends in a spanwise direction between a root end and a tip end of the second blade, in a thickness direction between the leeward shell and the windward shell, and in a chordwise direction between a leading edge and a trailing edge of the second blade,
wherein the main windward reinforcement structure, the main leeward reinforcement structure, the rear windward reinforcement structure, and the rear leeward reinforcement structure of the second blade each extend in the spanwise direction of the second blade, wherein the main windward reinforcement structure and the main leeward reinforcement structure of the second blade forms a second main reinforcement structure and the rear windward reinforcement structure and the rear leeward reinforcement structure of the second blade forms a second rear reinforcement structure arranged between the second main reinforcement structure and the trailing edge of the second blade;
wherein the first blade and the second blade have the same external geometry,
wherein the main windward reinforcement structure and the main leeward reinforcement structure of the first main reinforcement structure and the second main reinforcement structure comprise layers of pultruded carbon fibres,
wherein a number of layers of pultruded glass fibres in the rear windward reinforcement structure and the rear leeward reinforcement structure of the first rear reinforcement structure is different from a number of layers of pultruded glass fibres in the rear windward reinforcement structure and the rear leeward reinforcement structure of the second rear reinforcement structure,
wherein manufacturing the first blade comprises the sub-step of:
arranging a first trailing edge reinforcement structure between the first rear reinforcement structure and the trailing edge of the first blade, the first trailing edge reinforcement structure comprising fibres engaging the leeward shell and/or the windward shell and aligned with the trailing edge of the first blade.

2. The method according to claim 1, wherein the fibres of the first trailing edge reinforcement structure are primarily unidirectionally arranged in a first fabric of material.

3. The method according to claim 2, wherein the first fabric of material is in the form of tape.

4. The method according to claim 1, wherein manufacturing the second blade comprises the sub-step of:
arranging a second trailing edge reinforcement structure between the second rear reinforcement structure and the trailing edge of the second blade, the second trailing edge reinforcement structure comprising fibres engaging the leeward shell and/or the windward shell and aligned with the trailing edge of the first second,
wherein the first trailing edge reinforcement structure and the second trailing edge reinforcement structure are different,
wherein, optionally, the fibres of the second trailing edge reinforcement structure are primarily unidirectionally arranged in a second fabric of material.

5. The method according to claim 1, wherein the number of layers of pultruded glass fibres in the rear windward reinforcement structure and/or the rear leeward reinforcement structure of the first rear reinforcement structure is greater than the number of layers of pultruded glass fibres in the respective rear windward reinforcement structure and/or the rear leeward reinforcement structure of the second rear reinforcement structure.

6. The method according to claim 1, wherein the rear windward reinforcement structure and the rear leeward reinforcement structure of the first rear reinforcement structure comprises layers of pultruded carbon fibres and/or the rear windward reinforcement structure and the rear leeward reinforcement structure of the second rear reinforcement structure comprises layers of pultruded carbon fibres.

7. The method according to claim 1, wherein a number of layers of pultruded carbon fibres in the rear windward reinforcement structure and/or the rear leeward reinforcement structure of the first rear reinforcement structure is different from a number of layers of pultruded carbon fibres in the respective rear windward reinforcement structure and/or the rear leeward reinforcement structure of the second rear reinforcement structure.

8. The method according to claim 7, wherein the number of layers of pultruded carbon fibres in the rear windward reinforcement structure and/or the rear leeward reinforcement structure of the first rear reinforcement structure is smaller than the number of layers of pultruded carbon fibres in the respective rear windward reinforcement structure and/or the rear leeward reinforcement structure of the second rear reinforcement structure.

9. The method according to claim 1, wherein a total number of layers of pultruded fibres and a thickness resulting thereof in the rear windward reinforcement structure is the same in the first rear reinforcement structure and the second windward reinforcement structure, and/or
wherein a total number of layers of pultruded fibres and a thickness resulting thereof in the rear leeward reinforcement structure is the same in the first rear reinforcement structure and the second windward reinforcement structure.

10. The method according to claim 1, wherein, within a first airfoil section of the first blade, the rear windward reinforcement structure and the rear leeward reinforcement structure of the first rear reinforcement structure has a first stiffness in the spanwise direction,
wherein, within a second airfoil section of the second blade, the rear windward reinforcement structure and the rear leeward reinforcement structure of the second rear reinforcement structure has a second stiffness in the spanwise direction,
wherein a position of the first airfoil section in the first blade corresponds to a position of the second airfoil section in the second blade,
wherein the first stiffness is less than the second stiffness.

11. The method according to claim 10 when it depends on claim 4, wherein, within the first airfoil section, the first trailing edge reinforcement structure has a first supplementary stiffness in the spanwise direction,
wherein, within the second airfoil section, the second trailing edge reinforcement structure has a second supplementary stiffness in the spanwise direction,
wherein the first supplementary stiffness is greater than the second supplementary stiffness.

12. The method according to claim 1, wherein the main windward reinforcement structure and the main leeward reinforcement structure of the first main reinforcement structure have the same number of layers of pultruded fibres as the respective main windward reinforcement structure and the main leeward reinforcement structure of the second main reinforcement structure, and/or
wherein the main windward reinforcement structure and the main leeward reinforcement structure of the first main reinforcement structure have the same material composition of layers of pultruded fibres as the respective main windward reinforcement structure and the main leeward reinforcement structure of the second main reinforcement structure.

13. The method according to claim 1, wherein a placement of the first main reinforcement structure in the first blade is the same as a placement of the second main reinforcement structure in the second blade; and/or
wherein a placement of the first rear reinforcement structure in the first blade is the same as a placement of the second rear reinforcement structure in the second blade.

14. A family of wind turbine blades, wherein each blade of the family comprises:
a root end and a tip end, the blade extending in a spanwise direction between the root end and the tip end;
a leading edge and a trailing edge, the blade extending in a chordwise direction between the leading edge and the trailing edge;
a leeward shell and a windward shell, the blade extending in a thickness direction between the leeward shell and the windward shell;
a main reinforcement structure, the main reinforcement structure comprising a main windward reinforcement structure engaging the windward shell and extending in the spanwise direction of the blade and a main leeward reinforcement structure engaging the leeward shell and extending in the spanwise direction of the blade; and
a rear reinforcement structure, the rear reinforcement structure comprising a rear windward reinforcement structure engaging the windward shell and extending in the spanwise direction of the blade and a rear leeward reinforcement structure engaging the leeward shell and extending in the spanwise direction of the blade, the rear reinforcement structure being arranged between the main reinforcement structure and the trailing edge,
wherein the family comprises at least a first blade and a second blade, the first blade and the second blade having the same external geometry,
the main reinforcement structure of the first blade being a first main reinforcement structure, the rear reinforcement structure of the first blade being a first rear reinforcement structure, the main reinforcement structure of the second blade being a second main reinforcement structure, and the rear reinforcement structure of the second blade being a second rear reinforcement structure,
wherein the main windward reinforcement structure and the main leeward reinforcement structure of the first main reinforcement structure and the second main reinforcement structure comprise layers of pultruded carbon fibres,
wherein a number of layers of pultruded glass fibres in the rear windward reinforcement structure and the rear leeward reinforcement structure of the first rear reinforcement structure is different from a number of layers of pultruded glass fibres in the rear windward reinforcement structure and the rear leeward reinforcement structure of the second rear reinforcement structure,
wherein the first blade further comprises a first trailing edge reinforcement structure extending in the spanwise direction of the first blade and being arranged between the first rear reinforcement structure and the trailing edge of the first blade,
wherein the first trailing edge reinforcement structure comprises fibres engaging the leeward shell and/or the windward shell and aligned with the trailing edge of the first blade.

15. The family of blades according to claim 14, wherein the family of blades are manufactured according to the method of claim 1.
